(19) United States
(12) Patent Application Publication
(10) Pub. No.: US 2014/0185297 A1
(43) Pub. Date: Jul. 3, 2014

(54) GRILLE LIGHT DEVICE

(71) Applicant: Chao-Chuan Chen, Taichung City (TW)

(72) Inventor: Chao-Chuan Chen, Taichung City (TW)

(21) Appl. No.: 13/732,439

(22) Filed: Jan. 2, 2013

(51) Int. Cl. F21V 21/00

(52) U.S. Cl. CPC F21V 21/00
USPC 362/249.14

(57) ABSTRACT

A grille light device includes a base having a plurality of receiving rooms. Each receiving room has a plurality of protrusions protruded from one side thereof. A conductor is disposed in the base and has a plurality of first power pins. A plurality of position members is pivotally assembled on the base and at a top of another side of each corresponding receiving room. Each positioning member has a position lever. A plurality of light strips is assembled in the receiving room. One end of each light strip has a second power pin corresponding to each corresponding first power pin. Wherein when each light strip is assembled in each corresponding receiving room, one surface of a left side of each light strip is supported by the corresponding protrusions and another surface of a right side of each light strip is supported by the position levers of the corresponding positioning members.

### BACKGROUND OF THE INVENTION

1. Field of the Invention

The present invention relates to a light device, and more particularly to a grille light device which is easy and convenient for a user to assemble or disassemble.

2. Description of Related Art

Grille light device is one of a common light device in offices, stores and residences. The grille light device is usually assembled on ceiling or light gauge steel frame to provide the illumination. A basic grille light device comprises a light box, a reflective plate, a plurality of tube lights and a grille. The light box is assembled onto the ceiling or the light gauge steel frame and is used to receive and secure the tube lights; the reflective plate is disposed in the light box and is usually made of metals so as to distribute the light; the tube lights are assembled in the light box so as to create a light source; and the grille is assembled to the light box and covers the tube lights; the grille is used to reduce glare and increase an efficiency of light guiding; the grille could be formed as a variety of shapes, such as round grilles, shading louvers, screen grilles and so on. Recently, the tube lights are replaced by light-emitting diodes (LEDs) since LEDs are eco-friendly and energy-saving.

A conventional grille light device comprises a base, a diffuser and a light body. The base has a plurality of frames; each frame has two ends; and each end of each frame is connected to each corresponding end of each adjoining frame by a connecting device. The diffuser is assembled with the base and supports the light body. The light body is assembled on the base and the diffuser securely, and has at least one LED and at least one aluminum plate. Since the LED creates just a point light source and in order to provide enough illumination, a plurality of LEDs is usually assembled on the base of the conventional grille light device. To assemble the LEDs on the base, the LEDs are connected with the plurality of aluminum plates which has a plurality of electric cords assembled thereon, and then the LEDs and aluminum plates are assembled on the base via a plurality of fasteners.

Although the conventional grille light device is eco-friendly, long-term use and anti-glare, the conventional grille light device encounters problems in assembling or disassembling when changing the LEDs of the light body. In order to assemble or disassemble the LEDs, the frames of the base have to be disassembled firstly by unfastening the connecting devices; and then, the aluminum plates are disassembled by removing the fasteners; as a result, the LEDs are separated from the electric cords and the aluminum plates. Therefore, the process of assembling or disassembling of the conventional grille light device is very complicated and tedious.

The present invention has arisen to mitigate and/or obviate the disadvantages of the conventional grille light device. Further benefits and advantages of the present invention will become apparent after a careful reading of the detailed description with appropriate reference to the accompanying drawings.

### SUMMARY OF THE INVENTION

The main objective of the present invention is to provide an improved grille light device.

To achieve the objective, a grille light device comprises a base having a plurality of receiving rooms opened thereon, each receiving room has a plurality of protrusions protruded from one side thereof, a tip of each protrusion extends toward another side of each receiving room; a conductor is disposed in the base, the conductor has a plurality of first power pins, each first power pin is located in each corresponding receiving room; a plurality of position members is pivotally assembled on the base and located at a top of another side of each corresponding receiving room, each positioning member has a position lever formed thereon, the positioning members is opposite to the protrusions; and a plurality of light strips is assembled in the receiving room, one end of each light strip has a second power pin corresponding to each corresponding first power pin, each second power pin electrically connects with each corresponding first power pin, a width of each light strip is shorter than a distance between the tip of each corresponding protrusion and another side of each corresponding receiving room. Wherein, the grille light device further comprises a thermal interface strip, the thermal interface strip is assembled on a back side of each light strip; the conductor is assembled onto the base via a screwing method; each protrusion is formed as semicircular-shaped; each light strip is assembled in each corresponding receiving room, a first distance is defined between the left side of each light strip and one side of each corresponding receiving room, a second distance is defined between the right side of each light strip and another side of each corresponding receiving room, the first distance and the second distance are both 0.1 to 0.5 centimeters.

Under this arrangement, when each light strip is assembled in each corresponding receiving room, one surface of the left side of each light strip is supported by the corresponding protrusions and another surface of the right side of each light strip is supported by the position levers of the corresponding positioning members.

### BRIEF DESCRIPTION OF THE DRAWINGS

FIG. 1 is a plan view of a grille light device of the present invention;

FIG. 2 is a partially enlarged view of a base;

FIGS. 3-4 are partially enlarged views for showing a light strip which is being disassembled;

FIG. 5 is a plan view for showing a thermal interface strip which is assembled with the light strip.

### DETAILED DESCRIPTION OF THE INVENTION

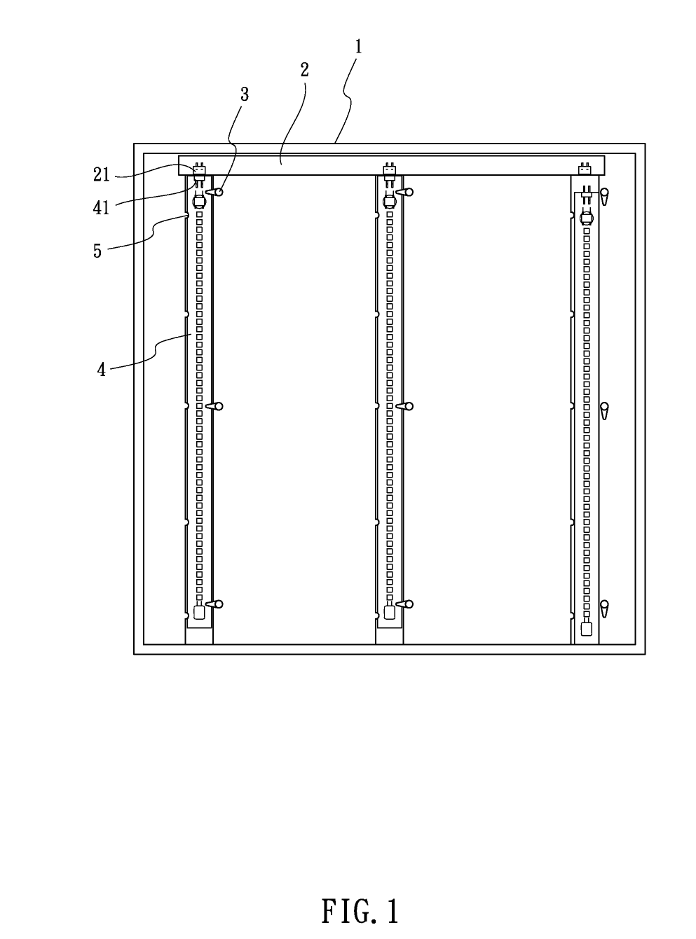

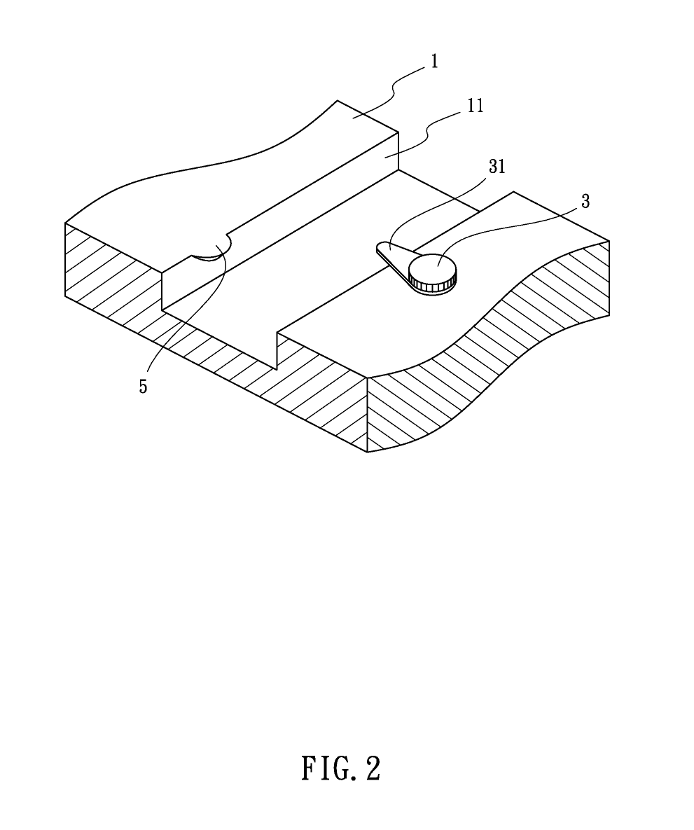

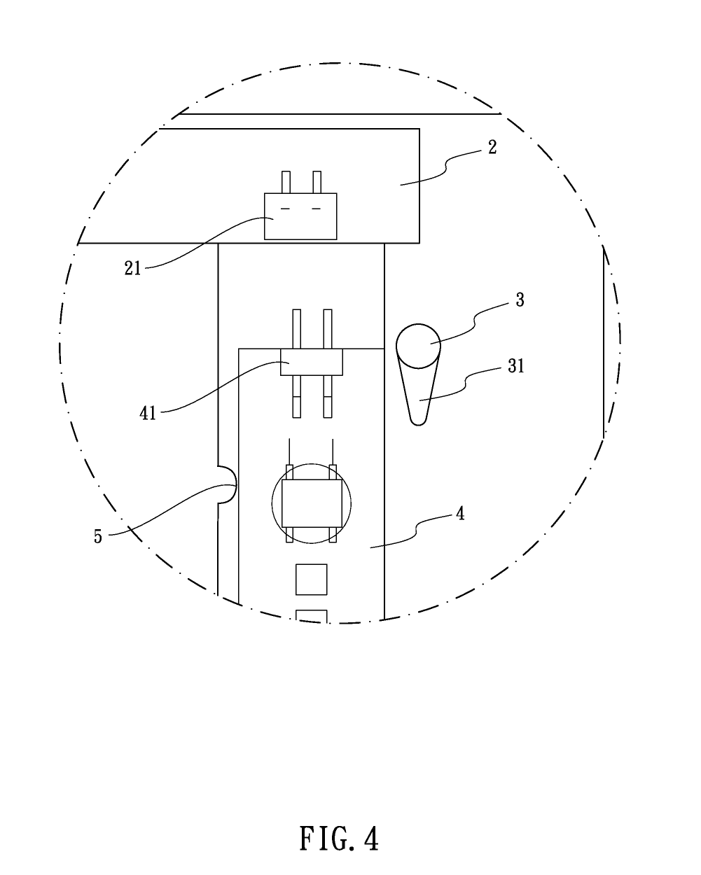

Referring to FIGS. 1-4, a grille light device in accordance with the present invention comprises a base 1, a conductor 2, a plurality of positioning members 3 and a plurality of light strips 4. The base 1 has a plurality of receiving rooms 11 opened thereon; each receiving room 11 has a plurality of protrusions 5 protruded from one side thereof; a tip of each protrusion 5 extends toward another side of each receiving room 11; and each protrusion 5 is formed as semicircular-shaped. The conductor 2 is disposed in the base 1; the conductor 2 has a plurality of first power pins 21; and each first power pin 21 is located in each corresponding receiving room 11. Each positioning member 3 is pivotally assembled on the base 1 and is located at a top of another side of each corresponding receiving room 11; and each positioning member 3 has a position lever 31 formed thereon; therefore, the positioning members 3 are all opposite to the protrusions 5. Each light strip 4 is assembled in the receiving room 11; one end of each light strip 4 has a second power pin 41 which is corresponding to each corresponding first power pin 21; each second power pin 41 electrically connects with each corresponding first power pin 21 so as to provide a power and light each light strip 4; and a width of each light strip 4 is shorter than a distance between the tip of each corresponding protrusion 5 and another side of each corresponding receiving room 11, so that each light strip 4 can be released from each corresponding receiving room 11. Referring to FIG. 4, a first distance D is defined between a left side of each light strip 4 and one side of each corresponding receiving room 11; and a second distance D′ is defined between a right side of each light strip 4 and another side of each corresponding receiving room 11. The first distance D and the second distance D′ are both 0.1 to 0.5 centimeters so as to provide a space which dissipates a heat from each light strip 4 and makes each light strip 4 movable in each corresponding receiving room 11.

Under this arrangement, when each light strip 4 is assembled in each corresponding receiving room 11, one surface of the left side of each light strip 4 is supported by the corresponding protrusions 5 and another surface of the right side of each light strip 4 is supported by the position levers 31 of the corresponding positioning members 3; therefore, each light strip 4 is confined in each corresponding receiving room 11. When a user needs to disassemble one light strip 4 from the base 1, the user just rotates the corresponding positioning members 3 on the base 1 until the position levers 31 of the corresponding positioning members 3 do not support another surface of the right side of said one light strip 4; as a result, said one light strip 4 can be released from the corresponding receiving room 11 of the base 1 because the corresponding positioning members 3 do not support another surface of the right side of said one light strip 4. Hence, the grille light device of the present invention is easy and convenient for the user to assemble or disassemble the light strips 4.

Besides, the second power pin 41 of each light strip 4 electrically connects with each corresponding first power pin 21 so as to provide a power and light each light strip 4. Therefore, a connection between the second power pin 41 of each light strip 4 and each corresponding first power pin 21 is individual. Therefore, when the user needs to replace one broken light strip 4 in the base 1 with another light strip 4, the user just needs to disassemble the broken light strip 4 from the corresponding receiving room 11 and assemble another light strip 4 into the corresponding receiving room 11, rather than disassemble the whole base 1 firstly as the prior art.

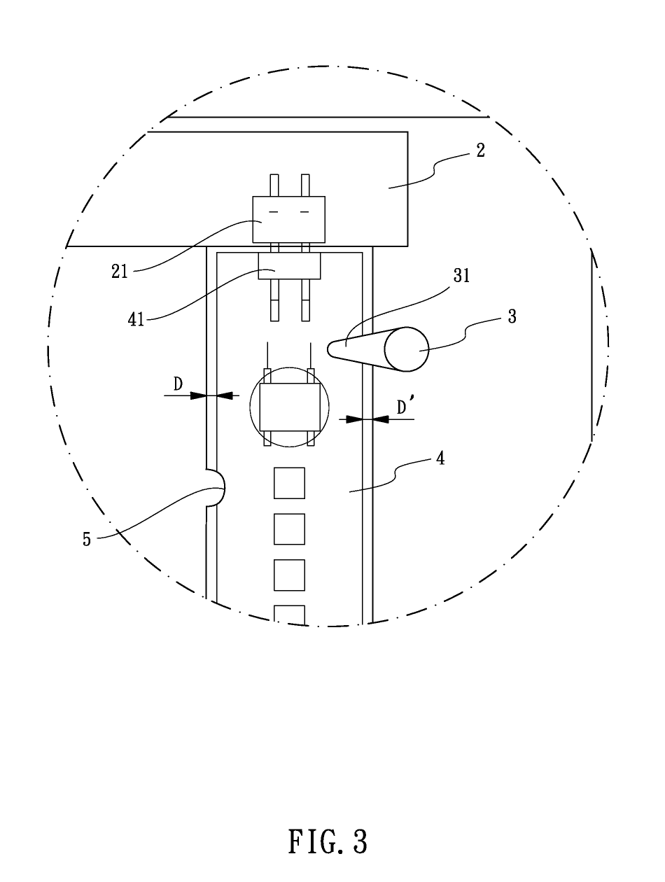

Referring to FIGS. 3-4, the steps of replacing one light strip 4 are described as following.

1. Axially moving one light strip 4 away from the corresponding first power pin 21 so as to release the second power pin 41 of one light strip 4 from the corresponding first power pin 21 of the conductor 2.

2. Rotating the corresponding positioning members 3 on the base 1 until the position levers 31 of the corresponding positioning members 3 do not support one light strip 4.

3. Transversely moving one light strip 4 toward another side of the corresponding receiving room 11 until the corresponding protrusions 5 do not support one light strip 4; as a result, one light strip 4 is disassembled from the corresponding receiving room 11 of the base 1. Therefore, the present invention is easy and convenient for the user to assemble or disassemble the light strips 4 because of the positioning member 3 and the protrusion 5.

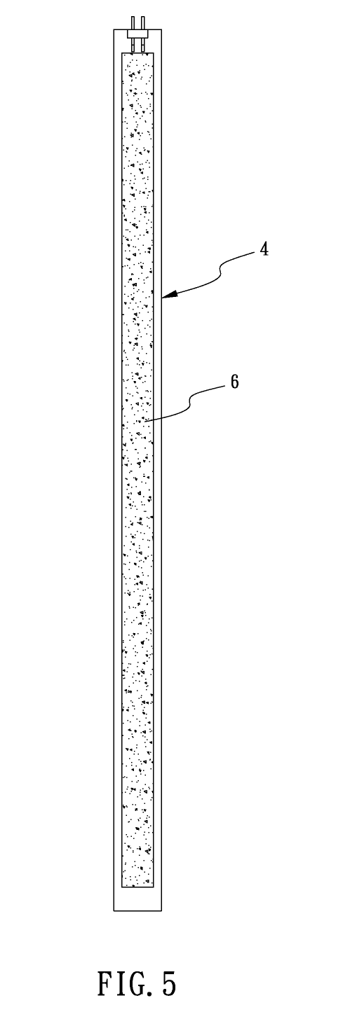

Referring to FIG. 5, the grille light device of the present invention further comprises a thermal interface strip 6. The thermal interface strip 6 is assembled on a back side of each light strip 4 so as to dissipate the heat from each light strip 4 quickly and stabilize a state of each light strip 4.

Moreover, the conductor 2 is assembled onto the base 1 via a plurality of screws. When the conductor 2 is broken and needs to be removed, the user only needs to unscrew the screws; as a result, the conductor 2 can be removed. Therefore, the present invention is easy and convenient for the user to assemble or disassemble the conductor 2 because of the screws.

Although the invention has been explained in relation to its preferred embodiment, it is to be understood that many other possible modifications and variations can be made without departing from the spirit and scope of the invention as hereinafter claimed.

What is claimed is:

1. A grille light device comprising:
a base having a plurality of receiving rooms opened thereon, each receiving room having a plurality of protrusions protruded from one side thereof, a tip of each protrusion extending toward another side of each receiving room;
a conductor disposed in the base, the conductor having a plurality of first power pins, each first power pin located in each corresponding receiving room;
a plurality of position members pivotally assembled on the base and located at a top of another side of each corresponding receiving room, each positioning member having a position lever formed thereon, the positioning members being opposite to the protrusions; and
a plurality of light strips assembled in the receiving room, one end of each light strip having a second power pin corresponding to each corresponding first power pin, each second power pin electrically connecting with each corresponding first power pin, a width of each light strip being shorter than a distance between the tip of each corresponding protrusion and another side of each corresponding receiving room;
wherein when each light strip is assembled in each corresponding receiving room, one surface of the left side of each light strip is supported by the corresponding protrusions and another surface of the right side of each light strip is supported by the position levers of the corresponding positioning members.

2. The grille light device as claimed in claim 1, wherein the grille light device further comprises a thermal interface strip; the thermal interface strip is assembled on a back side of each light strip.

3. The grille light device as claimed in claim 1, wherein the conductor is assembled onto the base via a screwing method.

4. The grille light device as claimed in claim 1, wherein each protrusion is formed as semicircular-shaped.

5. The grille light device as claimed in claim 1, wherein each light strip is assembled in each corresponding receiving room; a first distance is defined between the left side of each light strip and one side of each corresponding receiving room; a second distance is defined between the right side of each light strip and another side of each corresponding receiving room; the first distance and the second distance are both 0.1 to 0.5 centimeters.
